(19) United States
(12) Patent Application Publication
(10) Pub. No.: US 2025/0061597 A1
(43) Pub. Date: Feb. 20, 2025

(54) PERCEPTION DIVERSITY FOR IDENTIFICATION OF OBJECTS IN ROBOTICS SYSTEMS AND APPLICATIONS

(71) Applicant: NVIDIA Corporation, Santa Clara, CA (US)

(72) Inventors: Jack ZHANG, Sam Jose, CA (US); Gordon GRIGOR, San Francisco, CA (US); Karsten PATZWALDT, San Francisco, CA (US); Riccardo MARIANI, Porto Azzurro (IT)

(21) Appl. No.: 18/511,828

(22) Filed: Nov. 16, 2023

(30) Foreign Application Priority Data
Aug. 16, 2023 (IT) 102023000017313

(51) Int. Cl. G06T 7/593

(52) U.S. Cl. CPC G06T 7/593; G06T 2207/10021

(57) ABSTRACT

The present disclosure relates to detecting objects in detection zones using multiple analysis techniques. The multiple analysis techniques may be used to analyze sensor data corresponding to the detection zones. The multiple analysis techniques may be selected based at least on at least two of the analysis techniques of the multiple analysis techniques having a computational diversity by performing different types of computational analyses on the sensor data with respect to each other, and at least two analysis techniques of the multiple analysis techniques having implementation diversity by being implemented on different types of computing platforms with respect to each other.

### BACKGROUND

Object detection is a vital task for many robotics and autonomous systems. For example, object detection systems may be used to detect objects (e.g., persons, animals, substances, stationary objects, dynamic objects, and/or other objects), and more particularly may be tasked with detecting objects within certain areas that may be designated as object detection zones (“detection zones”). For example, detection systems may be used to determine whether an object is within a certain proximity to an operational area of a machine, where the operational area may include an area within a certain distance of the machine and may thus be designated as a detection zone.

Object detection may be used with respect to certain safety measures to help prevent machines from performing unsafely and/or damaging property. For example, regions or spaces around or included in an operational area of a robot that are designated as potentially hazardous areas may be included in detection zones in which performing object detection is crucial. For instance, in response to making an object detection corresponding to a detection zone, a detection system may cause the machine to operate in a particular manner-such as to slow down, or to cease operating. For example, the machine may be caused to stop in response to the system making the detection corresponding to the detection zone.

Some current approaches to making detections corresponding to detection zones includes use of a two-dimensional (2D) planar laser rangefinder or a lidar to sweep within detection zones. For example, the 2D planar laser rangefinder or the lidar may be used to sweep a circular plane ranging from 270 to 360 degrees around the machine. In these instances, the detections may be made when an object intersects the circular plane. For example, the 2D planar laser rangefinder or the lidar may detect an object within the circular plane. However, such an approach is limited to detections in 2D spaces and may not be applicable in some instances. For example, such approach may not properly make the detection in three-dimensional (3D) planes. For instance, the object may be above the circular plane being swept, such as flying objects and/or hanging objects. The 2D planar laser rangefinder or the lidar may not properly detect the flying objects and/or the hanging objects.

Further, some of the current approaches may be limited due to use of a particular detection technique. For example, a particular detection system may use the particular detection technique to analyze input data obtained using a sensor to determine the detections. For instance, the particular detection technique may include an algorithm used to analyze the input data. In some instances, the algorithm may not be suitable for a particular detection zone or specifications of the example system. For example, the algorithm may need to be preconfigured to calculate a specific set of disparities, which may prevent inference-time adjustment. Such algorithms may not be suitable for detection zone requirements that may require flexibility of leveraging trade-offs between latency and depth quantization at inference time.

### SUMMARY

According to one or more embodiments of the present disclosure, one or more systems and/or methods may be configured to detect objects in detection zones using multiple analysis techniques. For example, in some embodiments, sensor data corresponding to the detection zones, obtained using one or more sensors, may be analyzed using the multiple analysis techniques. In some embodiments, the multiple analysis techniques may be selected based on at least two analysis techniques of the multiple analysis techniques having a computational diversity by performing different types of computational analyses on the sensor data with respect to each other. In some embodiments, to further increase robustness and diversity, at least two analysis techniques of the multiple analysis techniques may be respectively implemented on different types of computing or hardware platforms, devices, or components.

One or more embodiments of the present disclosure may help in more accurately detecting the presence of objects in detection zones. Additionally or alternatively, the detection of the objects may be performed in a diverse manner that may allow for increased robustness in the detection. For example, according to one or more embodiments, the diverse manner of the detection may increase the accuracy of detecting objects in respective detection zones in varying detection conditions.

### BRIEF DESCRIPTION OF THE DRAWINGS

The present systems and methods for detecting objects in detection zones and applications are described in detail below with reference to the attached figures, wherein:

FIGS. 1A-1B illustrate an example system configured to determine a detection of an object in detection zones, in accordance with one or more embodiments of the present disclosure:

FIG. 1C illustrates an example diagram 130 visualizing a tradeoff between safety and productivity in combining one or more detection algorithms, in accordance with one or more embodiments of the present disclosure:

FIG. 1D illustrates of an example detection zone, in accordance with some embodiments of the present disclosure:

FIGS. 2A-2B illustrate an example system configured to determine a detection of an object in a detection zone, in accordance with one or more embodiments of the present disclosure:

FIG. 3 is an example flow diagram illustrating a method for detecting objects in detection zones of a machine, in accordance with one or more embodiments of the present disclosure:

FIG. 4A is an illustration of an example autonomous vehicle, in accordance with one or more embodiments of the present disclosure;

FIG. 4B is an example of camera locations and fields of view for the example autonomous vehicle of FIG. 4A, in accordance with one or more embodiments of the present disclosure:

FIG. 4C is a block diagram of an example system architecture for the example autonomous vehicle of FIG. 4A, in accordance with one or more embodiments of the present disclosure:

FIG. 4D is a system diagram for communication between cloud-based server(s) and the example autonomous vehicle of FIG. 4A, in accordance with one or more embodiments of the present disclosure:

FIG. 5 is a block diagram of an example computing device suitable for use in implementing one or more embodiments of the present disclosure; and

FIG. 6 is a block diagram of an example data center suitable for use in implementing one or more embodiments of the present disclosure.

### DETAILED DESCRIPTION

Systems and methods related to detecting objects in certain areas referred to as “detection zones” are disclosed in the present disclosure. In some embodiments, the detection zones may include any area of interest surrounding or near a machine. For example, the detection zones may include operational areas of a vehicle or a machine (generally referred to as “machine”). For example, the operational areas of the machine may include any area at which a portion of the machine may move or operate. For instance, an operational area corresponding to a robotic arm may include any area at which or to which the robotic arm may move. Additionally or alternatively, the operational areas may include any area at which an operation by the machine may introduce something into the area. For example, the operational areas may include an area at which electromagnetic waves, radiation, etc. (e.g., x-rays, laser beams, etc.) may be present due to an emission by the machine.

Additionally or alternatively, the detection zones may include hazard areas or restricted areas (generally referred to as “restricted areas”). For example, the restricted areas may include areas that may require restricted access with respect to persons, animals, substances, or objects due to confidentiality considerations, contamination considerations, safety considerations, among others. In some instances, the restricted areas may include areas that may be restricted with respect to access and/or objects or substances (e.g., dust, radiation, certain gases, etc.). In the present disclosure, general reference to an object or objects may include persons, or substances, or any other applicable type of thing that may enter the detection zones.

In some embodiments, the detection zones may include areas related to ego-machines. For example, the detection zones may include areas in front of, behind, and/or around an ego-machine. Additionally or alternatively, the detection zones may include areas above or below the ego-machine. In these or other embodiments, the detection zones may move along with the ego-machine as the ego-machine moves. For example, illustrated graphically, a particular detection zone may be represented as a bounding shape surrounding the ego-machine. The bounding shape may be determined as a certain size and shape depending on the ego-machine and detection capabilities or requirements of the machine. For instance, the bounding shape may be determined to cover areas that should be kept clear for the ego-machine to avoid collisions. In these and other embodiments, as the ego-machine moves, the bounding shape may move along with the ego-machine. For example, the bounding shape may retain a position and/or orientation relative to a current location and/or pose of the ego-machine.

In some embodiments, a detection of an object may be made based at least on detection data that may be generated using one or more sensors. For example, in some embodiments, the detection system may include one or more analysis algorithms that may be applied to the detection data to determine a detection of an object in the detection zone.

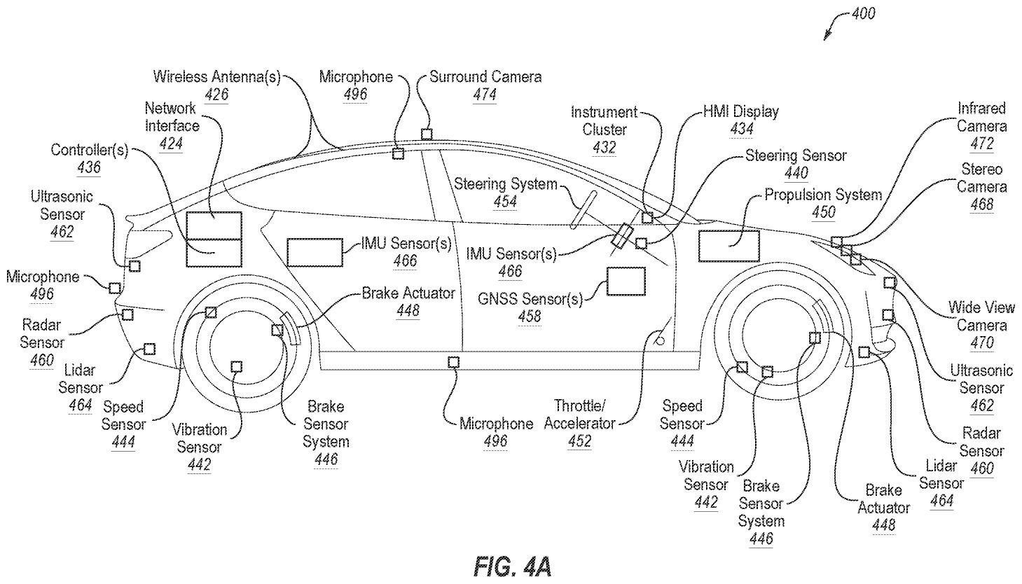

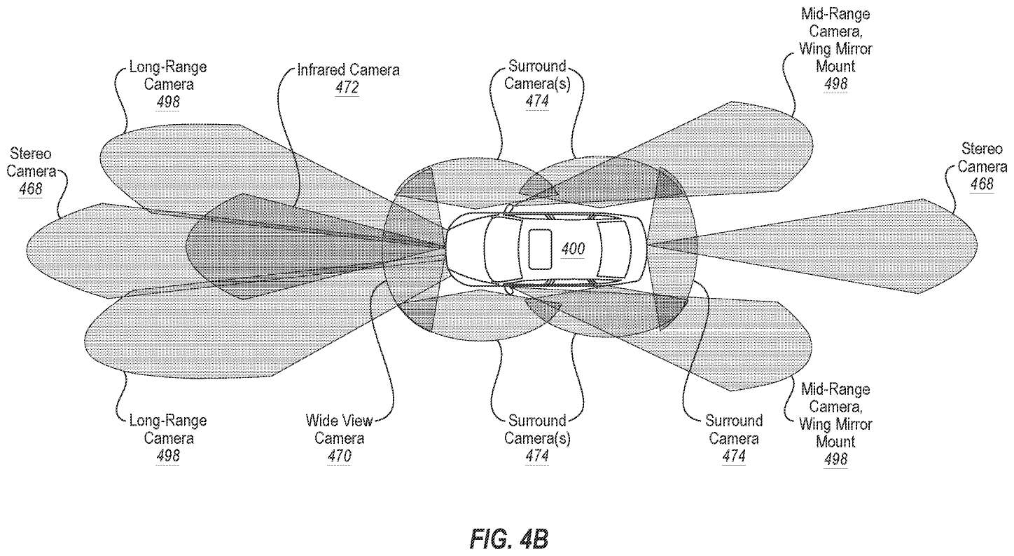

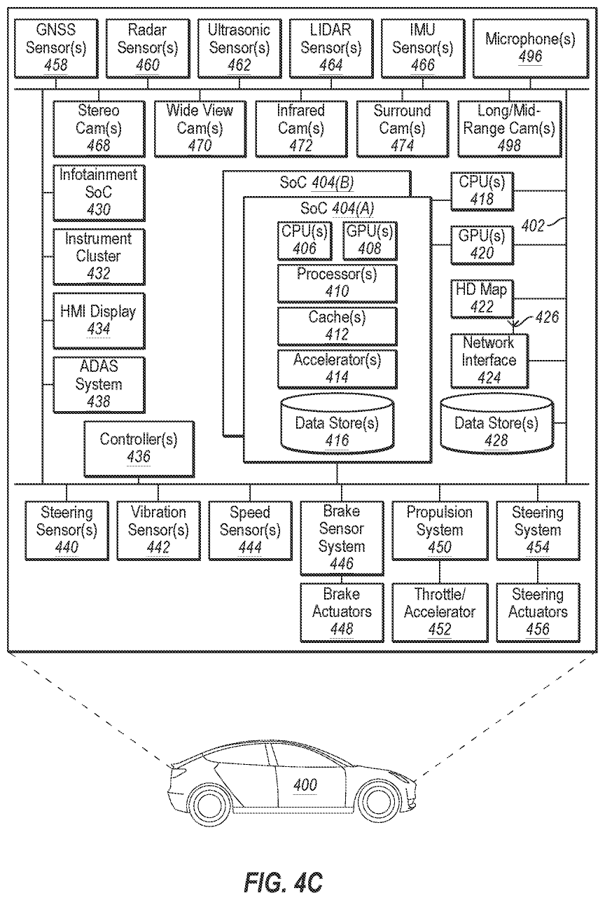

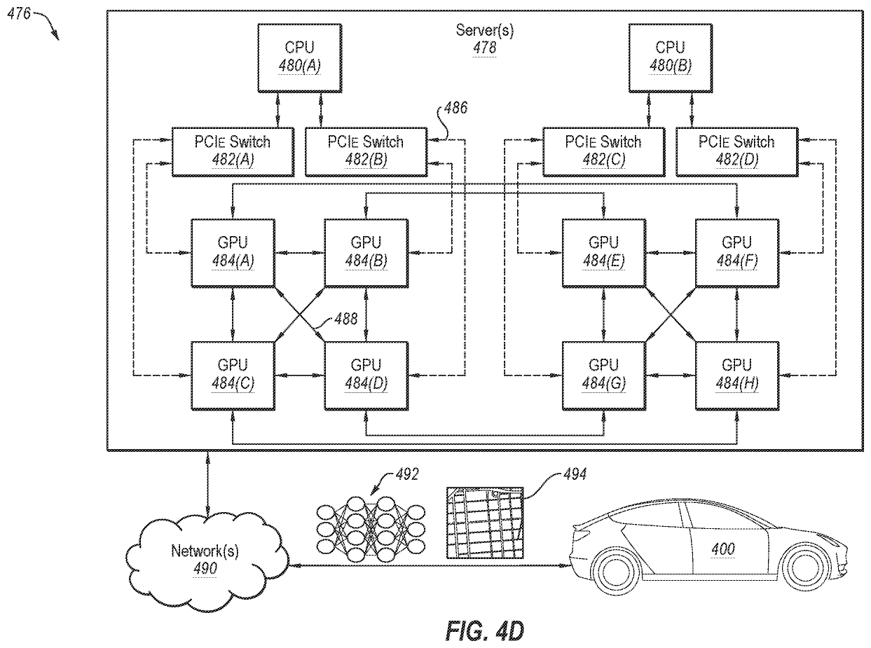

One or more of the embodiments disclosed herein may relate to detecting objects in detection zones associated with one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 400 (alternatively referred to herein as “vehicle 400” or “ego-machine 400”) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI (such as by employing one or more language models such as one or more large language models (LLMs)), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations (e.g., systems that implement one or more language models, such as large language models (LLMs)), systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

The embodiments of the present disclosure may help improve accuracy of detecting objects in detection zones. For example, in one or more embodiments of the present disclosure, the detection system may perform the detection of the objects in a diverse manner that may improve the accuracy of the detection system. For example, according to one or more embodiments, the detection system may use different techniques that may be used for object detection in the detection zones. In some embodiments, the different techniques may be selected based on computational diversity between the different techniques. Additionally or alternatively, the different techniques may be selected based on implementational diversity between the different techniques.

One or more embodiments of the present disclosure may help improve accuracy over some traditional approaches to object detection. For example, some traditional approaches to object detection may include use of a two-dimensional (2D) planar laser rangefinder or a lidar. For instance, the 2D planar laser rangefinder or the lidar may be used to sweep a circular plane ranging from 270 to 360 degrees around the detection system. In these instances, the detection may be made when an object intersects the circular plane. However, such approach may be limited to 2D spaces and/or may be limited in height (based on a type of lidar sensor deployed) and may not be applicable in certain instances. For instance, such approach may not be effective when the detection zones include vertical planes. For example, the detection zones may include areas where ground is not flat and/or where objects may be located in different vertical planes. With the 2D planar laser rangefinder or the lidar, uneven ground may lead to false-positive detections due to some parts of the ground intersecting the circular plane.

Further, some traditional approaches may include usage of a particular computing platform. For example, the particular computing platform may include a particular hardware platform and/or a particular software platform that may obtain sensor data and process the sensor data to determine the detection. However, the use of the particular computing platform may carry risk of common failures. For example, a computational error may occur on the particular computing platform which may cause false positive detections and/or missed detections.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

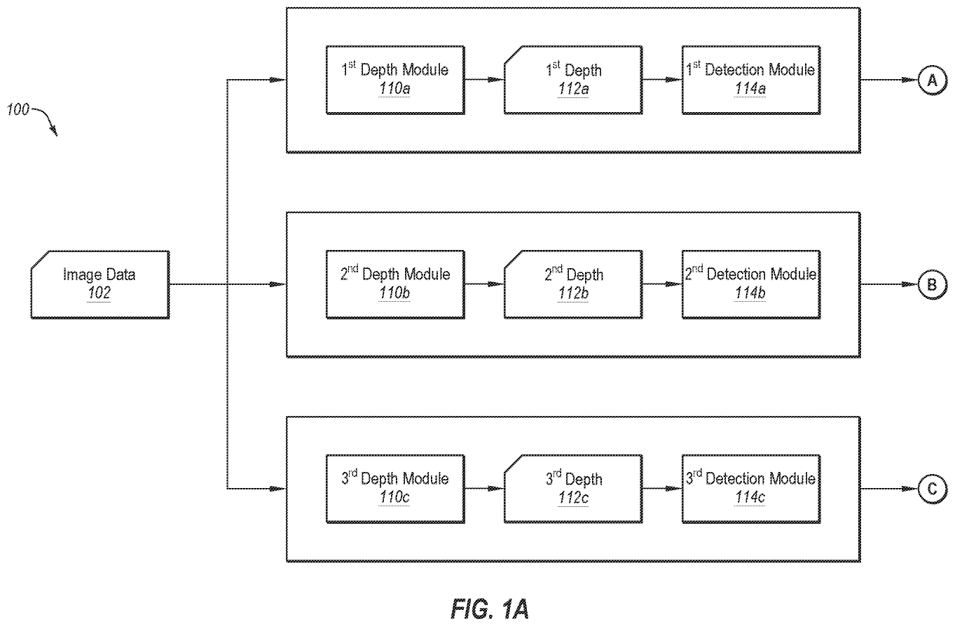

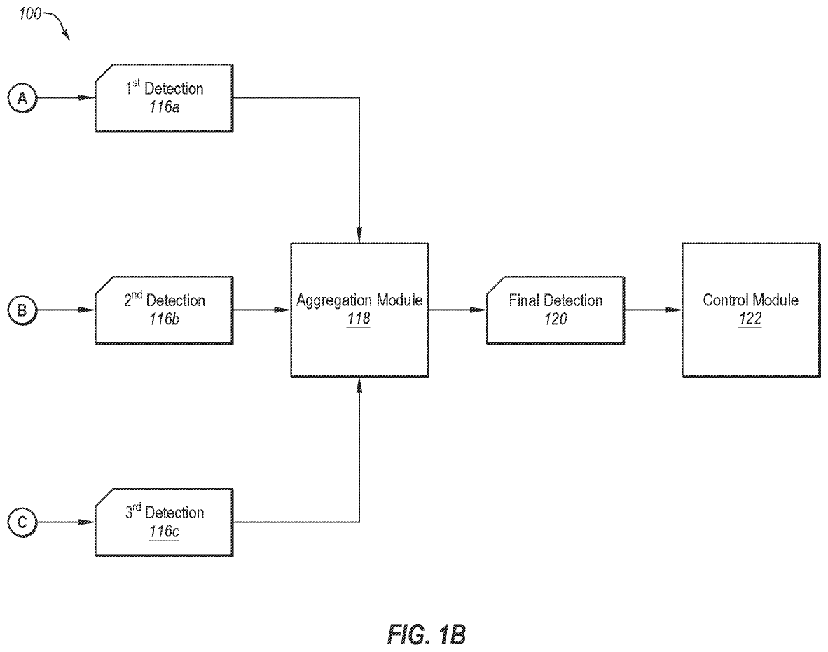

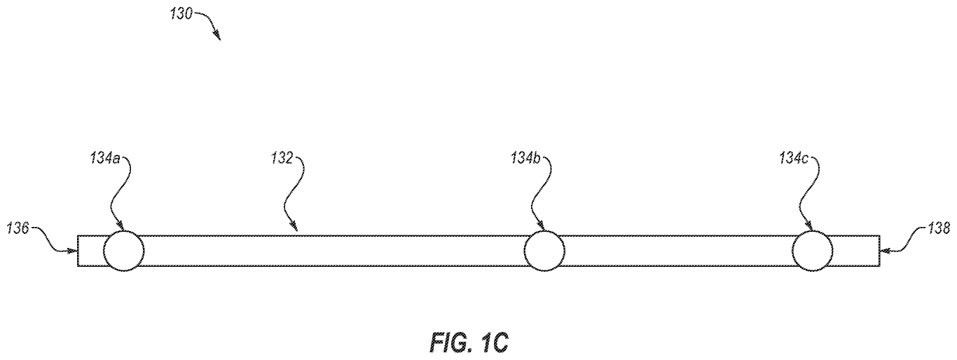

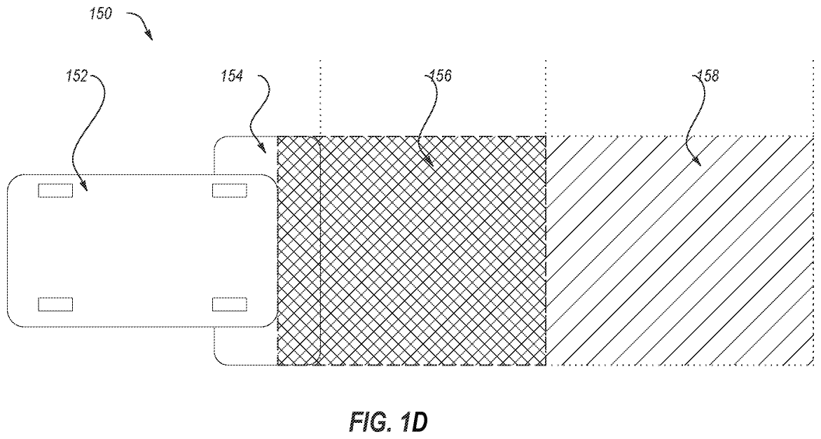

With respect to the figures, FIGS. 1A-1B illustrate an example system 100 configured to determine a detection of an object in a detection zone, in accordance with one or more embodiments of the present disclosure. In some embodiments, the system 100 may be implemented on a machine. For example, the system 100 may be implemented on the vehicle 400 of FIGS. 4A-4D. For instance, the system 100 may be configured to detect objects that are in a detection zone of the vehicle 400. In some instances, the system 100 may be used by the vehicle 400 to detect objects while the vehicle 400 is traveling. In another example, the system 100 may be implemented on a machine with moving parts (e.g., robot arms). In these instances, the system 100 may be configured to detect objects in operational areas of the machine (e.g., areas the robot arms may reach and/or need to safely operate).

As detailed herein, in general, the system 100 may include a first computing platform (“first platform”) 104, a second computing platform (“second platform”) 106, and a third computing platform (“third platform”). In some embodiments, the system 100 may include additional computing platforms. The first platform 104, the second platform 106, and the third platform 108 may be configured to determine a first detection 116a, a second detection 116b, and a third detection 116c, respectively based on image data 102 and/or other sensor data (e.g., lidar, radar, ultrasonic, etc.). As such, when referring to image data 102 herein, this may also include other types or modalities of sensor data.

The image data 102 may include any type of data representative of the detection zone. For example, the image data 102 may include an image depicting the detection zone. For example, in some embodiments, the image data 102 may be obtained using one or more sensors. The one or more sensors may include any suitable system, apparatus, or device that may be used to obtain the image data 102 such as laser scanners, camera systems, and/or any other suitable optoelectronic devices. In the present disclosure, a reference to an “image” may also refer to the image data corresponding thereto. Similarly, an image may include a representation of the image data, and other sensor data representations (e.g., range images, point clouds, etc.) associated with other sensor data modalities may also be used herein without departing from the scope of the present disclosure.

In some embodiments, the image data 102 obtained using the one or more sensors may include a certain number of pixels. For example, the certain number of pixels may depend on size of the image data 102, specification of the one or more sensors, specifications of computing platforms, etc. For example, one or more of the sensors may be relatively high-resolution sensors and may accordingly be used to generate image data with a greater number of pixels than one or more sensors that may have a lower resolution.

In some embodiments, the number of pixels and/or other properties of the image data 102 may be transformed. For example, the image data 102 obtained using the one or more sensors may be preprocessed using one or more preprocessing functions to be more suitable for processing by the first platform 104, the second platform 106, and/or the third platform 108. For instance, the image data 102 may be transformed to a certain size (e.g., number of pixels) and format. The one or more preprocessing functions may include any suitable functions to convert raw image data into a more suitable format for processing. For example, the one or more preprocessing functions may include format conversion, noise reduction, tone mapping, multi-exposure merging, distortion correction, cropping, downscaling, rectification, among others.

In some embodiment, one or more objects may be represented in the image data 102. Also, in the present disclosure, objects that are represented in the image data 102 and depicted by corresponding images may also be referred to as being “present in” or “in” the image data 102 or corresponding image. Further, pixels of the image data 102 that include information corresponding to objects may be referred to as being “occupied by” objects. Similarly, a pixel that depicts an object or portion of the object may be referred to as “including” the object or the object may be referred to as being “present in” or “in” the pixel. In addition, the area and/or objects depicted or represented by the image data 102 and/or a pixel may be referred to as “corresponding to” the image data 102 and/or the pixel. Moreover, in the present disclosure, a reference to a pixel may include a reference to the one or more objects or areas corresponding to the pixel.

In some embodiments, the image data 102 may include information regarding which of the pixels are occupied by the one or more objects. For example, a particular pixel may be deemed occupied where at least a part of the particular pixel includes at least a part of the one or more objects. Contrastingly, the particular pixel may be deemed not occupied where no parts of the one or more objects are present in the particular pixel. For example, the particular pixel may correspond to an area of the detection zone without any objects. For instance, the particular pixel may correspond to an area including background, sky, etc.

In some embodiments, the one or more sensors may include a stereo camera module. In these and other embodiments, the stereo camera module may include two or more cameras that may be used to generate a three-dimensional (3D) depiction of an area. In some embodiments, the area depicted by the stereo camera module may correspond to the detection zone. In some embodiments, the two or more cameras may be configured to obtain images of the area from different positions. For example, the stereo module may include a first camera and a second camera, where the first camera may be configured to obtain a first image of the area, and the second camera may configure to obtain a second image of the area. In some instances, the first camera and the second camera may be offset from each other such that the first camera and the second camera have different perspectives. In these and other embodiments, the first image and the second image may have a disparity due to the different perspectives. For example, the one or more objects found in the first image and the second image may occupy different sets of pixels. In these instances, the disparity may indicate a displacement (e.g., a distance) between the different sets of pixels of the first image and the second image. In some embodiments, a presence of the disparity may indicate a presence of depth in the area, and the disparity may be used to estimate depth. In some embodiments, the image data 102 may include at least the first image and the second image. Additionally or alternatively, the image data 102 may include the disparity between the first image and the second image.

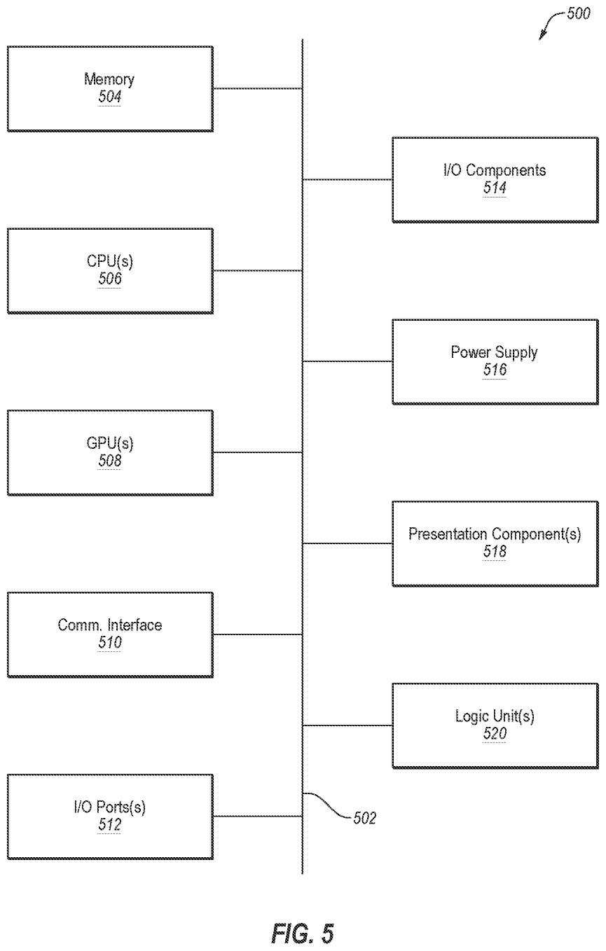

In some embodiments, the first platform 104, the second platform 106, and the third platform 108 may include a first depth module 110a, a second depth module 110b, and a third depth module 110c (collectively referred to herein as “depth modules 110”) respectively. In some embodiments, one or more of the depth modules 110 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs), optical flow accelerators (OFAs)), programmable vision accelerators (including one or more direct memory address (DMA) systems and/or vector processing units (VPUs)), and/or other processor types. In some other instances, one or more of these modules may be implemented using a combination of hardware and software. In the present disclosure, operations described as being performed by a respective module may include operations that the respective module may direct a corresponding computing system to perform. In these or other embodiments, one or more of these modules may be implemented by one or more computing devices, such as that described in further detail with respect to FIGS. 4A-4D, 5, and/or 6. In some embodiments, the first depth module 110a, the second depth module 110b, and the third depth module 110c may be implemented using different hardware with respect to one another. For example, in some embodiments, the first depth module 110a may be implemented using an OFA, the second depth module 110b may be implemented using a DLA, and the third depth module 110c may be implemented using a GPU.

In some embodiments, the one or more depth modules 110 may be configured to obtain the image data 102. The one or more depth modules 110 may be further configured to identify the one or more objects depicted by the image data 102. For example, the one or more depth modules 110 may be configured to determine a number of objects and/or locations of the objects present in the image data 102. Additionally or alternatively, the one or more depth modules 110 may be configured to determine a depth corresponding to the one or more objects identified in the image data 102. For example, the first depth module 110a may be configured to determine a first depth 112a, the second depth module 110b may be configured to determine a second depth 112b, and the third depth module 110c may be configured to determine a third depth 112c. The first depth 112a, the second depth 112b, and the third depth 112c may be referred to generally or collectively as “the depths 112” or “the depth 112”.

In some embodiments, one or more of the depths 112 may include a relationship between the one or more objects and a reference point. For example, in some embodiments, one or more of the depths may be determined as a continuous depth that may refer to a distance of the one or more objects from the reference point—e.g., an origin or rig coordinate corresponding to the machine or ego-machine, such as a center of a rear axle of a vehicle, or a point along a robotic arm of a robot.

Additionally or alternatively, the one or more depths 112 may correspond to disparity of one or more objects from the reference point. For example, objects further away from the reference point may be at greater depth compared to objects closer to the reference point. In these and other embodiments, the distance corresponding to one or more of the depths 112 may be represented using any suitable measuring metrics. For example, the distance may be represented in meters, centi-meters, inches, among others.

In some embodiments, the reference point may correspond to a location of the one or more sensors. For example, the reference point may be determined as the location of the stereo camera module. In these instances, one or more of the depths 112 of the one or more objects may be determined as the distance from the stereo camera module to the one or more objects. In some embodiments, the reference point may be determined as any other suitable locations in reference to the system 100 and the detection zone. For example, in some embodiments, the reference point may be located at center, edge, front, rear, or any other parts of the machine implementing the system 100.

Additionally or alternatively, in some embodiments, one or more of the depths 112 may be represented in a binary classification format. For example, the depth may refer to whether the one or more objects are closer or further than a particular depth plane. For example, one or more depth planes may be located, each of the one or depth planes being at a different distance from the reference point. In these and other embodiments, the locations of one or more objects may be compared against the particular depth plane to determine whether the one or more objects are closer or further from the reference point than the particular depth plane. In some embodiments, one or more objects may be compared against multiple depth planes which may provide finer depth quantization.

For example, a location of a particular object may be compared against a first depth plane and a second depth plane. The particular object may be determined as being further away from the reference point than the first depth plane but closer than the second depth plane. In these instances, the particular object may be located in between the first depth plane and the second depth plane. In these instances, comparing the one or more objects against more depth planes may lead to more detailed depth quantization of the one or more objects. In these and other embodiments, one or more of the depths 112 may accordingly indicate the relative depth relationships between the particular object and the depth planes.

In some embodiments, distances between the one or more depth planes may be configurable according to specified depth quantization. For example, the distances between the one or more depth planes may be narrower where a greater depth quantization is needed, and the distances between the one or more depth planes may be greater where a less depth quantization is needed.

In some embodiments, one or more of the depths 112 may be determined on a pixel-by-pixel basis for the pixels corresponding to the one or more objects. In some embodiments, different parts of the one or more objects may have different depths. In these and other embodiments, the depths of the one or more objects may be determined by determining respective depths for respective portions of the one or more objects corresponding to the pixels. For example, individual pixel depths may be determined for the pixels occupied by the one or more objects. For instance, a distance between the reference point and each of the pixels occupied by the one or more objects may be determined. In these and other embodiments, the individual pixel depths may be used to determine one or more of the depths 112 in the continuous depth format.

Additionally or alternatively, individual pixel depths for the pixels occupied by the one or more objects may be determined in a binary classification format. Such an approach may provide more detailed depth quantization than determining the depths of the one or more objects as a whole. For example, a part of an object represented by a particular pixel may be located closer than a certain depth plane to the reference point while rest of the object may be located further than the certain depth plane. Such an approach may indicate how only a small part of the object is at a certain depth.

In some embodiments, one or more of the depths 112 may be represented using a depth map. The depth map may include a 3D representation of depths of some (e.g., all) the pixels present in the image data 102. For example, the one or more objects may be projected to a 3D space based on the individual pixel depths. For instance, each of the pixels corresponding to the one or more objects may be placed at certain locations in the 3D space according to the reference point and the individual pixel depths.

In some embodiments, the one or more depth modules 110 may be configured to determine the depth of the one or more objects in diverse approaches. For example, the first depth module 110a may determine the depth in the continuous depth format while the second depth module 110b may determine the depth in the binary classification format. Additionally or alternatively, the diverse approaches may involve using machine-learning (ML) based techniques versus using one or more computer vision-based techniques. The diverse approaches may also include different nature in which data may be analyzed or aggregated. For example, some ML-based techniques may implement 2D or 3D convolution techniques as part of training and/or depth determination. Additionally or alternatively, other ML-based techniques may implement iterative refinement techniques, where each iteration improves upon estimates of a previous step, as part of the training and/or the depth determination.

In some embodiments, the diverse approaches may include differences among an ability to manipulate one or more parameters corresponding to the approaches. In these and other embodiments, some approaches may allow the one or more parameters to be manipulated during run-time. Additionally or alternatively, some of the diverse approaches may include a flexible range which may include an ability to define a certain range at or near run-time such that the approach is bound to estimating the depth only for objects within the defined range.

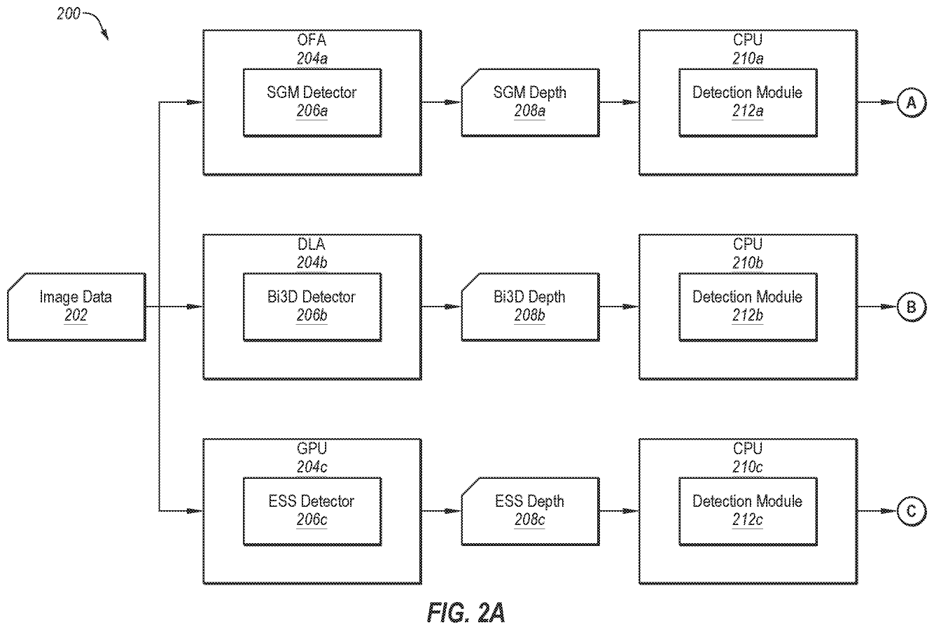

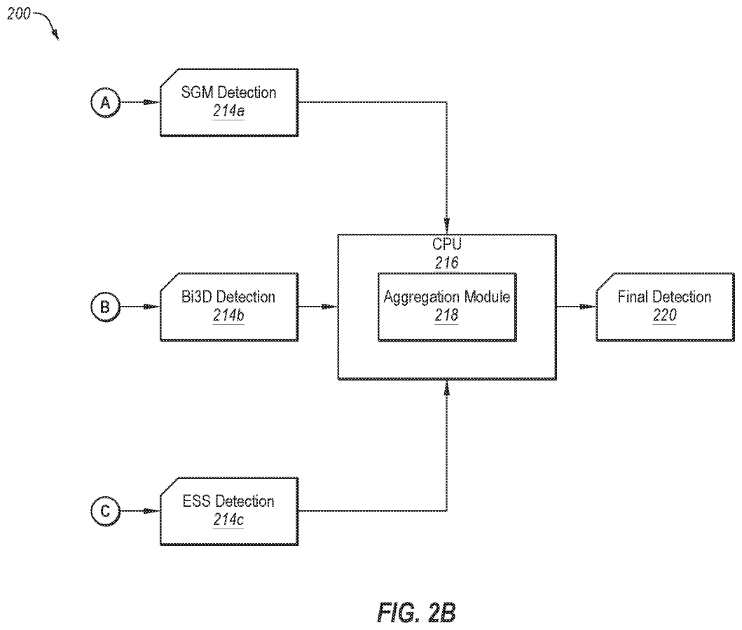

In some embodiments, the one or more depth modules 110 may be implemented on different computing platforms. For example, in some embodiments, the first platform 104, the second platform 106, and the third platform 108 may include hardware and/or software platforms where at least two of the first platform 104, the second platform 106, and the third platform 108 vary with respect to each other. In some embodiments, the different computing platforms may cause a difference in results of the one or more depth modules 110. The different computing platforms is discussed in more detail herein, at least with respect to FIGS. 2A-2B.

Additionally or alternatively, the one or more depth modules 110 may be configured to determine depth confidences. For example, the first depth 112a may include a first depth confidence. In some embodiments, the first depth confidence may be indicative of how confident the first depth module 110a is about the depth of the one or more objects determined by the first depth module 110a. For example, the first depth confidence may indicate how confident the first depth module 110a is of the depth determined for each of the one or more objects. In some embodiments, the first depth confidence may include how confident the first depth module 110a is of the depth determined for the pixels occupied by the one or more objects.

In some embodiments, the depth determined by the one or more depth modules 110 may be represented in a same format as the image data 102. For example, the image data 102 may be transformed to a 16-bit image format for the first depth module 110a. In these and other instances, the first depth 112 may also be represented in the 16-bit image format.

In some embodiments, the first platform 104, the second platform 106, and the third platform 108 may include a first detection module 114a, a second detection module 114b, and a third detection module 114c (collectively referred to herein as “detection modules 114”), respectively. In some embodiments, the detection modules 114 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), programmable vision accelerators (including one or more direct memory address (DMA) systems and/or vector processing units (VPUs)), and/or other processor types. In some other instances, one or more of these modules may be implemented using a combination of hardware and software. In the present disclosure, operations described as being performed by a respective module may include operations that the respective module may direct a corresponding computing system to perform. In these or other embodiments, one or more of these modules may be implemented by one or more computing devices, such as that described in further detail with respect to FIGS. 4A-4D, 5, and/or 6.

In some embodiments, the one or more detection modules 114 may be configured to obtain the one or more depths 112. The one or more detection modules 114 may be further configured to determine whether a depth of any object present in the one or more depths 112 is within a certain area of the detection zone. For example, the first detection module 114a may be configured to determine a first detection 116a, the second detection module 114b may be configured to determine a second detection 116b, and the third detection module 114c may be configured to determine a third detection 116c. The first detection 116a, the second detection 116b, and the third detection 116c may be referred generally or collectively as “the detections 116” or “the detection 116”.

In some embodiments, one or more of the detections 116 may indicate whether detections of objects are made within the detection zone. In some embodiments, the detections may be represented using one or more voxels. For example, the detection zone may be divided into the one or more voxels, or 3D cubes. The one or more voxels may create a 3D grid of cubes covering the detection zone. In some embodiments, the one or more voxels may be of the same size. In some embodiments, the size of the one or more voxels may be determined based on format of the one or more depths 112. For example, one or more of the depths 112 may be represented in the 16-bit image format. In these instances, the size of the one or more voxels may be determined to divide the detection zone according to the 16-bit image format. In some embodiments, the first detection 116a, the second detection 116b, and the third detection 116c may be configured to be of a same format. For example, the one or more voxels for the first detection 116a, the second detection 116b, and the third detection 116c may be located and/or sized identically. However, in other embodiments, the one or more voxels for the first detection 116a, the second detection 116b, and the third detection 116c may not be located and/or sized identically.

In some embodiments, one or more of the detection modules 114 may be configured to project the depth map representing one or more of the depths 112 onto the one or more voxels. For example, the pixels corresponding to different parts of the one or more objects may be placed on the 3D grid of cubes according to the individual pixel depths. In these and other embodiments, one or more of the detection modules 114 may be configured to determine which of the one or more voxels include depth of any of the one or more objects.

Additionally or alternatively, one or more of the detection modules 114 may be configured to determine whether the one or more objects detected within the detection zone are in certain areas of interest within the detection zone. For example, one or more of the detections 116 may indicate whether the depths of any of the one or more objects fall within the certain areas of interest. For example, the one or more voxels with at least a part of the one or more objects present may be examined to determine where the one or more objects are located with respect to the detection zone. In some embodiments, the certain areas of interest may include a part of the detection zone. For example, the certain areas of interest may include the part of detection zone that are within certain proximity from the machine implementing the system 100. For instance, areas in close proximity of the machine may be of a particular interest due to safety reasons. In these instances, the one or more voxels within certain distance of the machine may be designated as an area of interest. In these instances, the detections 116 may indicate whether any of the one or more voxels within the area of interest include any part of the one or more objects.

In some embodiments, the detection zone may include one or more areas of interest. For example, the detection zone may be divided into one or more sub-detection zones, each of the sub-detection zones covering an area of a particular interest. In some embodiments, the sub-detection zones may be determined based on operating characteristics of the machine. For example, the machine may include a moving part (e.g., a robotic arm) that may operate within a certain operating area. In these and other embodiments, a first sub-detection zone may include any area that the moving part may reach during operation, a second sub-detection zone may include any area that should be kept clear to prevent intervention of the operation, and a third sub-detection zone may include areas that the moving part may not reach. Examples of different sub-detection zones may be discussed in further detail with respect to FIG. 1D of the present disclosure.

Additionally or alternatively, one or more of the detection modules 114 may be configured to determine detection confidences. For example, the first detection 116a may include a first detection confidence, the second detection 116b may include a second detection confidence, and the third detection 116c may include a third detection confidence. In some embodiments, the first detection confidence may be indicative of how confident the first detection module 114a is about the detection of the one or more objects determined by the first detection module 114a. For example, the first detection confidence may indicate how confident the first detection module 114a is of the detection determined for each of the one or more objects. In some embodiments, the first detection confidence may include how confident the first detection module 114a is of the detection of the one or more objects in each of the one or more voxels. In some embodiments, the first detection confidence may be represented as a number within a confidence range (e.g., 0-100). In some embodiments, the first detection confidence, the second detection confidence, and the third detection confidence may be represented on the same confidence range.

In some embodiments, the system 100 may include an aggregation module 118. In some embodiments, the aggregation module 118 may be configured to obtain the first detection 116a, the second detection 116b, and the third detection 116c. The aggregation module 118 may further be configured to determine a final detection 120 based at least on the first detection 116a, the second detection 116b, and/or the third detection 116c.

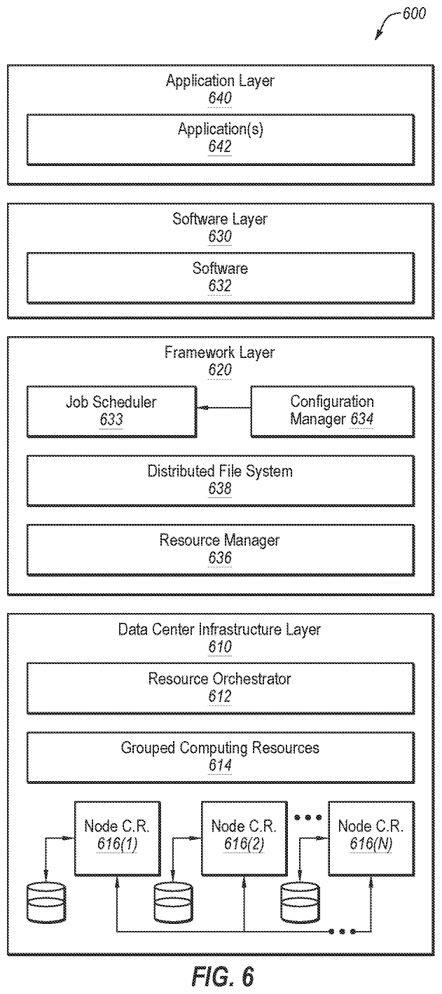

In some embodiments, the aggregation module 118 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs), optical flow accelerators (OFAs)), programmable vision accelerators (including one or more direct memory address (DMA) systems and/or vector processing units (VPUs)), and/or other processor types. In some other instances, the aggregation module 118 may be implemented using a combination of hardware and software. In the present disclosure, operations described as being performed by a respective module may include operations that the respective module may direct a corresponding computing system to perform. In these or other embodiments, the aggregation module 118 may be implemented by one or more computing devices, such as that described in further detail with respect to FIGS. 6A-6D, 7, and/or 8.

In some embodiments, the final detection 120 may indicate whether a detection of the one or more objects is made in the detection zone. For example, the final detection 120 may indicate whether the one or more objects are in the image data 102. Additionally or alternatively, the final detection 120 may indicate where in the detection zone the one or more objects are detected. In some embodiments, the final detection 120 may be a result of combining the first detection 116a, the second detection 116b, and the third detection 116c. By combining two or more of the detections 116, the final detection 120 may represent the detection of the one or more objects in the detection zone more accurately than using just one of the detections 116.

In some embodiments, the aggregation module 118 may be configured to aggregate the detections 116. For example, the first detection 116a, the second detection 116b, and the third detection 116c may be aggregated to determine the final detection 120. In some embodiments, the final detection 120 may be represented in the same format as the detections 116. For example, the final detection 120 may be represented using a final set of voxels which may be located and sized identical to the one or more voxels of the detections 116. In these and other embodiments, each voxel of the final set of voxels may have a corresponding voxel in each of the detections 116. In these and other embodiments, the final detection 120 may be determined in a voxel-by-voxel basis. For example, each of the final set of voxels of the final detection 120 may be determined by aggregating corresponding voxels from the detections 116. In these and other instances, each voxel of the final set of voxels of the final detection 120 may indicate whether an object is present in the corresponding voxel.

In some embodiments, the aggregating of the corresponding voxels may be done based on one or more combining algorithms. In the present disclosure, the combining algorithms may refer to any suitable method of combining the corresponding voxels from the detections 116 to determine the final set of voxels of the final detection 120.

In some embodiments, a particular combining algorithm may include a voting algorithm that may involve combining the detections 116 based at least on the detection confidences included in the detections 116. For example, for the final set of voxels (e.g., each voxel) of the final detection 120, the aggregation module 118 may analyze corresponding voxels associated with each of the detections 116 along with the detection confidences associated with the corresponding voxels.

For example, the first detection 116a may include the first detection confidence, the second detection 116b may include the second detection confidence, and the third detection 116c may include the third detection confidence. In these and other embodiments, the aggregation module 118 may place more weight on a detection with a higher detection confidence. For example, in instances in which a conflict exists between the detections 116, a detection with the higher confidence may prevail over another with a lower confidence.

For example, for a particular voxel of the final set of voxels, a corresponding first voxel from the first detection 116a may indicate a detection (e.g., an object is present in the corresponding first voxel), while a corresponding second voxel from the second detection 116b and a corresponding third voxel from the third detection 116c may indicate a non-detection (e.g., no object is present). In such an instance, the aggregation module 118 may observe the detection confidences of the first detection 116a, the second detection 116b, and the third detection 116c, and a detection with a higher confidence may be given more weight in determining the final detection 120 than detections with lower confidences. For example, the first detection 116a may indicate a full confidence (e.g., 100) of the detection for the particular voxel while the second detection 116b and the third detection 116c may each indicate a lower confidence (e.g., 30) of the non-detection for the particular voxel. In some of these instances, the detection of the first detection 116a may prevail over the non-detections of the second detection 116b and the third detection 116c, and despite only one out of three detections indicating a detection, the particular voxel of the final detection 120 may be determined as having a detection.

In such instances where the conflict exists between the detections 116, the aggregation module 118 may be configured to compare an overall confidence for a detection against an overall confidence for a non-detection. For example, in the above example, the overall confidence for the detection may be 100. Contrastingly, the overall confidence for the non-detection may be 60 (e.g., 30+30). Because the overall confidence for the detection is greater than the overall confidence for the non-detection, the aggregation module 118 may determine there is a detection in the particular voxel.

In some embodiments, the combining algorithm may include determining a tradeoff between safety and productivity. For example, FIG. 1C illustrates an example diagram 130 visualizing the tradeoff. In some embodiments, the diagram 130 may include a sliding scale 132 indicating a preference between safety and productivity, where an indicator 134 may be placed. In these and other embodiments, as the indicator 134 moves toward a first side 136 of the sliding scale 132, it may indicate the preference for safety over productivity. Contrastingly, as the indicator 134 slides toward a second end 138 of the sliding scale 132, the preference for productivity may increase and the preference for safety may decrease. In some embodiments, the aggregation module 118 may define a threshold requirement based at least on where the indicator 134 is on the sliding scale 132. In these and other embodiments, the threshold requirement may define a number of detections required from the detections 116 to determine a detection for the final detection 120. For example, a particular voxel of the final detection 120 may be determined as representing the detection of one or more objects in instances in which the threshold requirement number of corresponding voxels from the detections 116 indicate a detection.

In some embodiments, safety may be valued more than productivity. For example, the indicator 134 may be placed closer to the first side 136 than the second end 138 of the sliding scale 132, as illustrated by a first indicator 134a. In these instances, the threshold requirement may be set as a relatively low number, making it easier to satisfy and therefore easier to determine a detection for the final detection 120. For example, the threshold requirement may be set as a number indicative of slight minority or a minority of the detections 116. For instance, the slight minority may indicate a number less than half of the detections 116. For example, out of the first detection 116a, the second detection 116b, and the third detection 116c, only one corresponding voxel indicating a detection may be needed to find a detection in the particular voxel of the final detection 120.

In some embodiments, productivity may be deemed more important than safety. For example, the indicator 134 may be placed slightly more toward the second end 138 of the sliding scale 132 than the first side 136, as illustrated by a second indicator 134b. In these and other embodiments, the threshold requirement may be set as a number representing at least a majority of the detections 116. For example, in some embodiments, the threshold requirement may be set as a number representing a slight majority of the detections 116. For instance, the slight majority may indicate a number greater than half of the detections 116. In an instance with three detections, the threshold requirement may be set as two, where at least two of the three detections may be required to indicate a detection for the particular voxel for the final detection 120 to find a detection for the particular voxel. In another instance with five detections, at least three of the five detections may be required to indicate a detection.

In some embodiments, as an emphasis on productivity over safety grows, the threshold requirement may also increase. For example, instead of requiring three out of the five detections to indicate a detection, four detections may be required. In some embodiments, the highest level of productivity may be sought. For example, the indicator 134 may be placed at an end of the second end 138 of the sliding scale 132, as illustrated by a third indictor 134c. In these and other embodiments, a detection from all of the detections 116 may be required to find a detection for the particular voxel for the final detection 120. In some embodiments, the indicator 134 may be moved across the sliding scale 132 to adjust the threshold requirement according to specific needs of the machine. In some embodiments, depending on the particular safety criteria, the threshold may decrease for safety purposes—e.g., if any detection is identified, the system may determine a detection is present.

Returning to FIGS. 1A-1B, in some embodiments, after determining detection results with respect to each of the final set of voxels, the final detection 120 may be reduced to one or more general representations indicating whether an object was detected in one or more of the sub-detection zones. For example, the final detection 120 may include one or more binary values each indicating a detection of an object in one or more of the sub-detection zones. The one or more binary values (e.g., 0 for non-detection, 1 for detection) may simply indicate whether any object was detected in each of the sub-detection zones. In these and other embodiments, the one or more general representations may be determined based at least on the detection results corresponding to the final set of voxels. For example, the one or more general representations may be results of combining the detection results of the final set of voxels that are located within corresponding sub-detection zones.

In some embodiments, the combining of the detection results of the final set of voxels may include determining a number of the final set of voxels with a detection. For example, the number of the final set of voxels indicating a detection within a particular sub-detection zone may be obtained. In these and other embodiments, the number may be compared against a reduction threshold to determine the general representation for the particular sub-detection zone. The reduction threshold may define a number of voxels required to indicate a detection to find a detection for the general representation of the particular sub-detection zone. In some embodiments, the reduction threshold may be any number of voxels suitable for the machine implementing the system 100. For example, a particular machine may require an operating area free of any objects or particles. In these instances, the reduction threshold may be determined as low as a single voxel. For instance, in response to finding a detection in any one of the final set of voxels, the general representation may be determined to indicate a detection. In another example, the particular machine may only be interested in detecting larger objects. In these instances, the reduction threshold may be larger.

In some embodiments, the system 100 may include a control module 122. In some embodiments, the control module 122 may be configured to obtain the final detection 120. In some embodiments, the control module 122 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs), optical flow accelerators (OFAs)), programmable vision accelerators (including one or more direct memory address (DMA) systems and/or vector processing units (VPUs)), and/or other processor types. In some other instances, the control module 122 may be implemented using a combination of hardware and software. In the present disclosure, operations described as being performed by a respective module may include operations that the respective module may direct a corresponding computing system to perform. In these or other embodiments, the control module 122 may be implemented by one or more computing devices, such as that described in further detail with respect to FIGS. 6A-6D, 7, and/or 8.

In some embodiments, the control module 122 may further be configured to direct the machine implementing the system 100 to perform or stop performing one or more operations based at least on the final detection 120. For example, in some embodiments, the control module 122 may direct the machine to perform one or more mitigation operations in response to the final detection 120 indicating a detection. In some embodiments, the one or more mitigation operations may include any operations that may be performed to preserve and/or enhance safety. For example, in some embodiments, the mitigation operations may include a notification regarding a detection. For instance, the notification may include alerting security personnel, a warning alarm (e.g., visual and/or audio), or any other suitable type of notification.

In these and other embodiments, the mitigation operations may include causing a change in one or more operations of the machine corresponding to the sub-detection zone the detection was made. For example, the mitigation operations may include causing the machine to come to a protective stop, limiting the speed of the machine, and/or operating warning signals. The protective stop may include stopping one or more operations of the machine, such as any traveling or moving parts. In some embodiments, the control module 122 may select different mitigation operations depending on context and/or circumstances of the detection. For example, the control module 122 may select the mitigation operations depending on the sub-detection zone in which the detection was made.

For example, FIG. 1D illustrates of an example detection zone 150, in accordance with some embodiments of the present disclosure. In some embodiments, the detection zone 150 may be related to a machine 152. For example, in some embodiments, the machine 152 may be a vehicle, such as the vehicle 400 of FIG. 4. In some embodiments, the detection zone 150 may include one or more sub-detection zones. For example, the detection zone 150 may include a first sub-detection zone 154, a second sub-detection zone 156, and a third sub-detection zone 158. Although illustrated with three sub-detection zones, the detection zone may include any number of suitable sub-detection zones. Additionally or alternatively, although illustrated as rectangular boxes, the sub-detection zones may include any shape and/or format suitable for the machine 152. For example, the machine 152 may be interested in area surrounding the machine in a circular shape. Additionally or alternatively, the one or more sub-detection zones may apply similarly in all directions. For example, the one or more sub-detection zones may include areas behind, around, above, and/or below the machine 152.

In some embodiments, the detection zone 150 may be divided into the one or more sub-detection zones based at least on distance from a reference point. For example, the first sub-detection zone 154 may include an area within a first distance from the reference point, the second sub-detection zone 156 may include an area within a second distance from the reference point, excluding the area included in the first sub-detection zone, and the third sub-detection zone 158 may include an area within the third distance from the reference point, excluding the area covered by the first sub-detection zone and the second sub-detection zone. In some embodiments, the reference point may be located anywhere within or near the machine 152. For instance, the reference point may be located at a front end of the machine 152. In another instance, the reference point may be located at a center of the machine 152.

In some embodiments, the one or more sub-detection zones may be determined according to a level of limitation on access and/or infiltration by objects. For example, the first sub-detection zone 154 may cover an area in close proximity of the machine 152 and may include the highest level of limitation. For instance, the first sub-detection zone 154 may include physical operational areas of the machine 152. In these and other embodiments, the first sub-detection zone 152 may be designated as an exclusion zone. The exclusion zone may correspond to an area that is supposed to be always clear of objects for operation.

Additionally or alternatively, the second sub-detection zone 156 may be designated as or referred to as a protective zone. In some embodiments, the protective zone may include areas that include and/or that are around operational areas that may be potentially hazardous. For example, the second sub-detection zone 156 may include areas that the machine 152 may encounter objects while in motion, or may include areas that are immediately adjacent an exclusion zone-such that any object in these zones may soon enter the exclusion zones, and thus protective measure may be taken in advance.

Additionally or alternatively, the third sub-detection zone 158 may be designated as or referred to as a warning zone. In some embodiments, the warning zone may include areas that may not affect operations of the machine 152 but may without proper precautions.

In some embodiments, different mitigation operations may be operated by the machine 152 based at least on the one or more sub-detection zones in which a detection of one or more objects is made. For example, a detection in the first sub-detection zone, the second sub-detection zone, and the third sub-detection zone may lead to one or more different mitigation operations.

In some embodiments, the one or more mitigation operations corresponding to the first sub-detection zone 154 may include a protective stop and/or limiting speed of the machine 152. For example, one or more operations (e.g., any traveling or moving parts) of the machine 152 may be stopped and/or the speed of the one or more operations may be reduced. For instance, the one or more operations may be stopped and or reduced based at least on a location of the one or more objects detected in the first sub-detection zone 154. For example, in response to detecting the one or more objects closer to the machine 152, the one or more operations of the machine 152 may be stopped.

In some embodiments, the one or more mitigation operations corresponding to the second sub-detection zone 156 may include a protective stop. In this and other instances, the one or more objects detected in the second sub-detection zone 156 may not be close enough to come into the first sub-detection zone 154. In these instances, a travel of the machine 152 may be stopped to avoid colliding with the one or more objects.

Additionally or alternatively, in response to detecting the one or more objects in the third sub-detection zone 158, the mitigation operations may include operating the machine 152 at a limited speed and/or operating warning signals. In some embodiments, the warning signals may include any visual and/or sound signals that may make presence of the machine 152 known. For example, the warning signals may include an alarming noise that may alert workers in the third sub-detection zone of the presence of the machine 152.

FIGS. 2A-2B illustrates an example system 200 configured to determine a detection of an object in a detection zone, in accordance with one or more embodiments of the present disclosure. The system 200 may be an example implementation of the system 100 of FIGS. 1A-1B. For instance, the system 200 may illustrate the system 100 of FIGS. 1A-1B with specific types of detectors that may be used as the depth modules 110 implemented on specific types of computing platforms.

For example, the system 200 may include a Semi-Global Matching (SGM) detector 206a implemented on an optical flow accelerator (OFA) 204a, a Bi3D detector 206b implemented on a deep learning accelerator (DLA) 204b, and an Efficient Semi-Supervised (ESS) detector 206c implemented on a graphical processing unite (GPU) 204c. In some embodiments, the SGM detector 206a, the Bi3D detector 206b, and the ESS detector 206c may be collectively referred to as “depth detectors 206”. In these and other embodiments, a reference to a detector may include the type of detector (e.g., SGM, Bi3D, ESS) being used and/or the hardware platform (e.g., OFA, DLA, GPU) that is implementing the detector. For example, a reference to the SGM detector 206a may include a reference to the OFA 204a implementing the SGM detector 206a.

Although the depth detectors 206 are illustrated with specific examples, the depth detector 206 may include any other suitable type of detectors. For example, in some embodiments, the depth detectors 206 may include one or more of SGM, Bi3D, ESS, Block Matching (BM), Block Matching with Dynamic Programming (BMDP), Belief Matching (BM), Gradient Feature Matching (GF), Histogram of Oriented Gradient (HOG), among others. Additionally or alternatively, the depth detectors 206 may be implemented on any other suitable hardware platforms, although illustrated as being implemented on specific hardware platforms (e.g., OFA, DLA, and GPU). For example, the depth detectors 206 may be implemented using one or more of a central processing unit (CPU), a GPU, an OFA, a DLA, a programmable vision accelerator (PVA), a video input (VI) controller, an image signal processor (ISP), a video image compositor (VIC) engine, among others. Where different hardware is used for each detection, the hardware may, in embodiments, be free from common failures. As such, were one of the hardware elements to have an issue or defect and thus produce improper results, these issues or defects would not be propagated to the other hardware elements-thus allowing for accurate detection to continue even where one or more of the detectors or detection modules are taken offline or working improperly.

In these and other embodiments, the depth detectors 206 may be configured to determine depths based at least on an image data 202. In some embodiments, the image data 202 may include one or more images depicting the detection zone. For example, in some embodiments, the image data 202 may be obtained using one or more sensors. In some embodiments, the image data 202 may correspond to the image data 102 of FIG. 1A.

In some embodiments, the depth detectors 206 may obtain the image data 202 and determine depth of one or more objects present in the image data 202. In these and other embodiments, due to differences between one or more of the depth detectors 206, the determined depths may differ. For instance, the SGM detector 206a may be configured to determine a SGM depth 208a, the Bi3D detector 206b may determine a Bi3D depth 208b, and the ESS detector 206c may determine an ESS depth 208c. In the present disclosure, the SGM depth 208a, the Bi3D depth 208b, and the ESS depth 208c may be collectively referred to as “depths 208”. In these and other embodiments, one or more of the depths 208 may differ in respect to each other. For example, in some embodiments, one or more of the depth detectors 206 may correspond to different parameters characterizing the depth detectors 206.

In some embodiments, the SGM detector 206a may be a computer-vision based detector configured to determine the SGM depth 208a based at least on the image data 202, Additionally or alternatively, the SGM depth 208a may correspond to disparity of one or more objects from a reference point, where objects further away from the reference point may be at a greater depth compared to objects closer to the reference point.

In some embodiments, the SGM detector 206a may be configured to combine a local pixel matching cost function with global energy minimization constraints. For example, the SGM detector 206a may receive the image data 202 comprising a first image and a second image from a set of stereo cameras. For one or more pixels corresponding to the one or more objects in the first image, the SGM detector 206a may determine corresponding pixels in the second image. In some embodiments, the SGM detector 206a may apply a census transform to determine the corresponding pixels in the second image. For example, the SGM detector 206a may be configured to receive the image data 202 as a grayscale image represented in the luma format. For instance, the image data 202 may be represented in a 16-bit luma format and/or an 8-bit luma format. In these and other embodiments, the census transform may compare the one or more pixels to a number of neighboring pixels. For example, intensity (e.g., a luma value) of individual pixels may be compared against the intensity of the neighboring pixels. Results of the comparison may be represented as a number which may be used to determine corresponding pixels between the first image and the second image.

In some embodiments, the SGM detector 206a may perform a regression-based classification. For example, disparity values may be assigned to one or more pixels of the image data 202. In these and other embodiments, a reference to a pixel may include a reference to the one or more objects or areas corresponding to the pixel. The disparity values may be representative of distances from the one or more pixels in the first image to the corresponding pixels in the second image. In these and other embodiments, the disparity values may be used to determine distances of the one or more pixels from a particular reference point, the distances representing depths of the one or more pixels.

In some embodiments, the SGM detector 206a may be such that one or more of specifications may be adjusted during run-time. For example, the SGM detector 206a may adjust a number of iterations and/or accuracy of depth estimation. For instance, the SGM detector 206a may be iterated one or more times, where the iterations may refine cost output of the SGM detector 206a. Additionally or alternatively, output grid size granularity may be configurable. For example, the output grid size may be configured according to a desired quality of depth estimation. For instance, smaller grid size may provide more detailed depth estimation than larger grid size.

In some embodiments, the Bi3D detector 206b may be a ML-based detector configured to use a series of binary classifications to determine depths of the one or more objects in the image data 202. For example, instead of testing whether the one or more pixels are at a particular depth (e.g., assigning a disparity value to each pixel), the Bi3D detector 206b may classify the one or more pixels corresponding to the one or more objects as being closer or farther than a given depth plane. As such, the Bi3D detector 206b may implement the 2D convolution technique which aggregates features within a same depth plane. In some embodiments, the Bi3D detector 206b may determine depth in the binary classification format as described with further detail in FIGS. 1A-1B.

In some embodiments, the Bi3D detector 206b may include the flexible range. For instance, the Bi3D detector 206b may be able to estimate depth for objects in a specific range (e.g., area in close proximity of the machine). In some instances, the specific range may be determined by specifying depth planes to be used with the binary classifications. Additionally or alternatively, the Bi3D detector 206b may allow manipulation of parameters during run-time. For example, classifying the one or more pixels as being or farther than the given depth plane may be iterated for multiple depth planes. In some embodiments, by iterating the classification, finer depth quantization may be obtained.

In some embodiments, the Bi3D detector 206b may be configured to receive the image data 202 represented in the RGB format. For example, the image data 202 may be represented in a RGB8 format where one or more pixels present in the image data is represented by three colors (e.g., red, green, and blue), and each color is represented by an 8-bit integer. In some embodiments, the Bi3D detector 206b may be configured to receive the image data in any other suitable formats.

In some embodiments, the ESS detector 206c may be configured to determine the ESS depth 208c using a ML-based algorithm. In some embodiments, the ESS detector 206c may obtain the image data 202 in the RGB format similar to the Bi3D detector 206b. In these and other embodiments, the ESS detector 206c may be configured to apply a regression-based classification on the image data 202 to determine the ESS depth 208c based at least on the image data 202.

In these and other embodiments, while the ESS detector 206c may be similar to the Bi3D detector 206b in that both are ML-based detectors, the ESS detector 206c and the Bi3D detector 206b may include different approaches of representing depth. For instance, while the Bi3D detector 206b represents depth in binary classifications using different depth planes, the ESS detector 206c may represent depth in the continuous depth format. For example, the ESS detector 206c represents depth as a distance from a certain reference point rather than whether a particular pixel corresponding to an object is closer or further than a particular depth plane. In some embodiments, the continuous depth format adopted by the ESS detector 206c may be described in more detail with respect to FIGS. 1A-1B of the present disclosure.

In some embodiments, the ESS detector 206c may be configured to handle all depth levels at the same time to determine a probability of distribution over all the possible depth levels for the one or more objects in the image data 202. For example, the ESS detector 206c may implement the 3D convolution to aggregate data across multiple depth levels. For instance, the ESS detector 206c may extract features (e.g., the one or more objects) from the image data 202 and arrange the extracted features into a tensor extending over the multiple depth levels. In these and other embodiments, the tensor may be built and processed in a way that yields, for the one or more pixels corresponding to the extracted features of the image data 202, a probability distribution across multiple depth levels. For example, the probability distribution may indicate probabilities of the one or more pixels corresponding to the extracted features being in different depth levels. In some embodiments, the depths of the extracted features may be determined by finding the maximum value among the probability distribution. For instance, the one or more pixels corresponding to the extracted features may be determined to be located at a depth level with the highest probability.

In some embodiments, the depth detectors 206 may be implemented on different hardware platforms. For example, one or more of the depth detectors 206 may be implemented on different hardware platforms. In these and other embodiments, different hardware platforms may be selected based on the parameters characterizing the one or more depth detectors 206. For instance, the OFA 204a may be suitable for the SGM detector 206a because the OFA 204a may be dedicated to optical flow and/or stereo vision computations. For example, the OFA 204a may be configured to produce an optical flow and/or a disparity map from an image data. The DLA 204b may be suitable for the Bi3D detector 206b in that the DLA 204b is used to run neural networks. The GPU 204c may be suitable for the ESS detector 206c in that the GPU 204c may be used to provide high performance parallel computation which may be used by the ESS detector 206c to determine depth of the one or more objects across multiple depth planes at the same time.

In these and other embodiments, the depth detectors 206 may have different properties and/or parameters suitable for the hardware platform. In some embodiments, the different properties and/or parameters may improve robustness of the system 200. For instance, the different properties and/or parameters of the depth detectors 206 and/or the hardware platforms may reduce likeliness of an error in detection of the one or more objects. For example, differences between the depth detectors 206 may allow the system 200 to include different approaches in detecting the one or more objects. The different properties and/or parameters between the depth detectors, as discussed herein according to some embodiments, are illustrated and summarized in Table 1 below.

TABLE 1

| | | | | | | Inference- |
|---|---|---|---|---|---|---|
| Depth | | Input | Flexible | 3D vs. 2D | (R)egression vs. | time |
| Detector | ML/CV | Format | Range? | Convolution | (C)lassification | Parameters? |
| SGM | CV | Luma | N | — | R | Y |
| Bi3D | ML | RGB | Y | 2D | C | Y |
| ESS | ML | RGB | N | 3D | R | N |

In some embodiments, the system 200 may include a first detection module 212a, a second detection module 212b, and a third detection module 212c (collectively referred to as “detection modules 212”) which may correspond to the detection modules 114 of FIG. 1A. In some embodiments, the detection modules 212 may be configured to obtain the depths 208 to determine one or more detections. For instance, the first detection module 212a may be configured to determine a SGM detection 214a based at least on the SGM depth 208a, the second detection module 212b may be configured to determine a Bi3D detection 214b based at least on the Bi3D depth 208b, and the third detection module 212c may be configured to determine an ESS detection 214c based at least on the ESS depth 208c. In some embodiments, the SGM detection 214a, the Bi3D detection 214b and the ESS detection 214c may be collectively referred to as the “detections 214”.

In these and other embodiments, one or more of the detections 214 may indicate whether detections of objects are made within the detection zone. Additionally or alternatively, one or more of the detection modules 212 may be configured to determine whether the one or more objects detected within the detection zone are in certain areas of interest within the detection zone. In some embodiments, the determination of one or more of the detections 214 may include one or more operations described with respect to FIG. 1B corresponding to determining the detections 116.

In some embodiments, the detection modules 212 may be implemented on one or more CPUs. For example, the first detection module 212a may be implemented on a first CPU 210a, the second detection module 212b may be implemented on a second CPU, and the third detection module 212b may be implemented on a third CPU 210c. In some embodiments, the first CPU 210a, the second CPU 210b, and the third CPU 210c may be referring to a same CPU, for example, a single CPU may be implementing all of the detection modules 212. In some embodiments, one or more of the first CPU 210a, the second CPU 210b, and the third CPU 210c may be distinct from each other.

In some embodiments, the system 200 may include an aggregation module 218 implemented on a fourth CPU 216. In some embodiments, the fourth CPU 216 may be referring to the same CPU as one or more of the first CPU 210a, the second CPU 210b, and the third CPU 210c. In some embodiments, the fourth CPU 216 may be distinct from one or more of the other CPUs. In some embodiments, the aggregation module 218 may be configured to obtain the SGM detection 214a, the Bi3D detection 214b, and the ESS detection 214c. The aggregation module 218 may further be configured to determine a final detection 220 based at least on the SGM detection 214a, the Bi3D detection 214b, and/or the ESS detection 214c.

In some embodiments, the final detection 220 may indicate whether a detection of the one or more objects is made in the detection zone. For example, the final detection 220 may indicate whether the one or more objects are in the image data 202. Additionally or alternatively, the final detection 220 may indicate where in the detection zone the one or more objects are detected. In some embodiments, the final detection 220 may be a result of combining the SGM detection 214a, the Bi3D detection 214b, and the ESS detection 214c. By combining two or more of the detections 214, the final detection 220 may represent the detection of the one or more objects in the detection zone more accurately than using just one of the detections 214. In some embodiments, the aggregation module 218 may determine the final detection 220 by aggregating the detection 214. In some embodiments, the aggregation of one or more of the detections 214 may include one or more operations described with respect to FIG. 1B corresponding to aggregating the detections 116. In some embodiments, one or more control operations may be performed based on the final detection 220 such as described with respect to FIG. 1B.

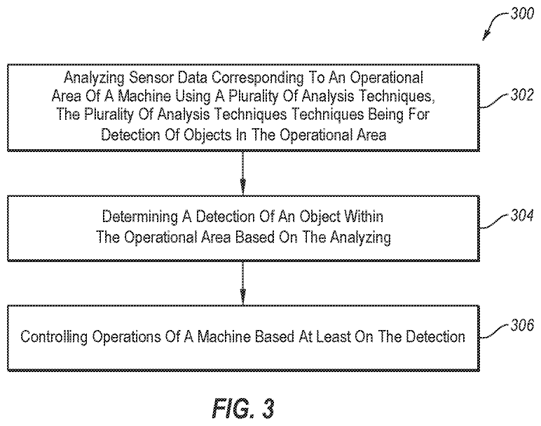

FIG. 3 is a flow diagram illustrating a method 300 for detecting objects in detection zones of a machine, in accordance with one or more embodiments of the present disclosure. In some embodiments, one or more of the operations of the method 300 may be performed with respect to the system 100 of FIGS. 1A-1B. One or more operations of the method 300 may be performed by any suitable system, apparatus, or device such as, for example, the system 100, the autonomous vehicle system(s) described with respect to FIGS. 4A-4D, computing device(s) described with respect to FIG. 5, and/or the data system(s) described with respect to FIG. 6 in the present disclosure.

The method 300 may include one or more blocks. Although illustrated with discrete blocks, the operations associated with one or more of the blocks of the method 300 may be divided into additional blocks, combined into fewer blocks, or eliminated, depending on the particular implementation.

In some embodiments, the method 300 may include block 302. At block 302, sensor data corresponding to an operational area of a machine may be analyzed using multiple analysis techniques. In some embodiments, the multiple analysis techniques may be for detection of objects in the operational area. In these and other embodiments, the multiple analysis techniques may include one or more depth techniques that may vary in how depth from a reference point is determined. For example, the one or more depth techniques may obtain the sensor data and determine depths of one or more objects present in the sensor data. In some embodiments, the sensor data may include a stereoscopic image data. For example, a stereo camera may be used to obtain the sensor data corresponding to the operational area of the machine.

In some embodiments, at least two of the analysis techniques of the multiple analysis techniques may have a computational diversity. For example, at least two of the analysis techniques may be configured to perform different types of computational analyses on the sensor data with respect to each other. In some embodiments, the computational diversity among the multiple analysis techniques may provide robust detection of objects. For instance, a single analysis technique may include certain computational errors and/or limitations. By implementing different analysis techniques, the certain computational errors and/or limitations may be reduced. In some embodiments, examples of the multiple analysis techniques may be discussed and illustrated further in the present disclosure, such as with respect to FIGS. 1A-1B.

In some embodiments, at least two of the analysis techniques of the multiple techniques may have an implementational diversity. For example, at least two of the analysis techniques may be implemented on different types of computing platforms with respect to each other. For example, a particular analysis technique may be implemented on a particular computing hardware that may be most suitable for the particular analysis technique. In some embodiments, example of the different computing platforms and corresponding analysis techniques may be discussed and illustrated further in the present disclosure, such as with respect to FIGS. 1A-1C.

At block 304, a detection of an object within the operational area may be determined based at least on the analysis. For example, based at least on results of the multiple analysis techniques, it may be determined whether one or more objects are present in the sensor data. For instance, individual detection results corresponding to respective analysis techniques of the multiple analysis techniques may be determined. In these and other instances, an overall detection result may be determined based at least on the individual detection results. In some embodiments, the determination of the overall detection result may include combining the individual detection results. In some instances, the individual detection results may be combined based on one or more combining algorithms to determine the overall detection result representing presence and/or location of the one or more objects within the operational area of the machine. In some embodiments, the determination of the overall detection result may include one or more operations described with respect to FIGS. 1A-IC, corresponding to determining the final detection 120.

At block 306, one or more operations of the machine may be controlled based at least on the detection of the object. For example, one or more mitigation operations may be performed by the machine in response to the detection of the object. In some embodiments, the one or more mitigation operations may vary according to where the detection of the object is made with respect to the machine. For instance, the one or more mitigation operations may vary depending at least on distance of the object from the machine. In some embodiments, examples of varying mitigation operations may be discussed and illustrated further in the present disclosure, such as with respect to FIGS. 1A-1B and ID.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more CPU(s), system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, and/or to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) 446 (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the HD map 422 of FIG. 4C), location data (e.g., the location of the vehicle 400, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424, which may use one or more wireless antenna(s) 426 and/or modem(s) to communicate over one or more networks. For example, the network interface 424 may be capable of communication over LTE, WCDMA, UMTS, GSM, CDMA2000, etc. The wireless antenna(s) 426 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward-facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may any number of wide-view cameras 470 on the vehicle 400. In addition, long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

One or more stereo cameras 468 may also be included in a front-facing configuration. The stereo camera(s) 468 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360-degree camera(s), and/or the like. For example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround-view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C is illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400 and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power: each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting, and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected to both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 404 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors: a CNN for distance estimation using data from camera sensors: a CNN for emergency vehicle detection and identification and detection using data from microphones: a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe-stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always-on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428, which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPD (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data, in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surrounding at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 100 m, with an accuracy of 2 cm-3 cm, and with support for a 100 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 200 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 400), while the 12V communication concept provides information about traffic further ahead. CACC systems may include either or both I2V and V2V information sources. Given the information of the vehicles ahead of the vehicle 400, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network that is trained and thus reduces the risk of false positives, as described herein.

The vehicle 400 may further include the infotainment SoC 430 (e.g., an in-vehicle infotainment system (IVI)). Although illustrated and described as an SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 400. For example, the infotainment SoC 430 may include radios, disk players, navigation systems, video players, USB and Bluetooth connectivity, carputers, in-car entertainment, Wi-Fi, steering wheel audio controls, hands-free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe-stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, include wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 632, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 600. In at least one embodiment, trained or deployed machine learning models corresponding to one or more neural networks may be used to infer or predict information using resources described in the present disclosure with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
analyzing sensor data corresponding to an operational area of a machine using a plurality of analysis techniques, the plurality of analysis techniques including:
at least two analysis techniques having a computational diversity by performing different types of computational analyses on the sensor data; and
at least two analysis techniques having implementation diversity by being implemented on different types of computing platforms;
determining a detection of an object within the operational area based at least on the analyzing; and
controlling one or more operations of the machine based at least on the detection.

2. The method of claim 1, wherein the sensor data comprises stereoscopic image data.

3. The method of claim 1, wherein the plurality of analysis techniques includes a plurality of depth techniques that vary in how depth from one or more reference points is determined.

4. The method of claim 3, wherein the plurality of depth techniques include at least a semi-global matching (SGM), a Bi3D, and an efficient semi-supervised depth (ESS).

5. The method of claim 1, wherein the different types of computing platforms include one or more of: a central processing unit (CPU), a graphics processing unit (GPU), an optical flow accelerator (OFA), a deep learning accelerator (DLA), a programmable vision accelerator (PVA), a video input (VI) controller, an image signal processor (ISP), or a video image compositor (VIC) engine.

6. The method of claim 1, wherein the determining of the detection of the object includes:
determining a plurality of individual detection results that correspond to respective analysis techniques of the plurality of analysis techniques; and
determining an overall detection result based at least on the plurality of individual detection results.

7. The method of claim 6, wherein the determining of the overall detection result includes:
determining the overall detection result by combining the plurality of individual detection results, wherein one or more individual detection results of the plurality of individual detection results are weighted with respect to the combining based at least on respective confidence levels related to the one or more individual detection results.

8. The method of claim 6, wherein the determining of the overall detection result includes:
determining the overall detection result based on whether a threshold number of the plurality of individual detection results indicate a detection.

9. The method of claim 8, wherein the threshold number is based at least on a target safety level associated with the operational area.

10. A system comprising:
one or more processors to cause performance of operations comprising:
analyzing sensor data corresponding to a detection zone using a plurality of analysis techniques, the plurality of analysis techniques including computational diversity and implementation diversity;
determining a detection of an object within the detection zones based at least on the analyzing; and
performing one or more operations based at least on the detection.

11. The system of claim 10, wherein the sensor data comprises stereoscopic image data.

12. The system of claim 10, wherein the plurality of analysis techniques includes a plurality of depth techniques that vary in how depth from one or more reference points is determined.

13. The system of claim 12, wherein the plurality of depth techniques include at least a semi-global matching (SGM), a Bi3D, and an efficient semi-supervised depth (ESS).

14. The system of claim 10, wherein the plurality of analysis techniques is implemented on a plurality of computing platforms including one or more of: a central processing unit (CPU), a graphics processing unit (GPU), an optical flow accelerator (OFA), a deep learning accelerator (DLA), a programmable vision accelerator (PVA), a video input (VI) controller, an image signal processor (ISP), or a video image compositor (VIC) engine.

15. The system of claim 10, wherein the determining of the detection of the object includes:
determining a plurality of individual detection results that correspond to respective analysis techniques of the plurality of analysis techniques; and
determining an overall detection result based at least on the plurality of individual detection results.

16. The system of claim 15, wherein the determining of the overall detection result includes:
determining the overall detection result by combining the plurality of individual detection results, wherein one or more individual detection results of the plurality of individual detection results are weighted with respect to the combining based at least on respective confidence levels related to the one or more individual detection results.

17. The system of claim 15, wherein the determining of the overall detection result includes:
determining the overall detection result based on whether a threshold number of the plurality of individual detection results indicate a detection.

18. The system of claim 17, wherein the threshold number is based at least on a target safety level associated with the detection zone.

19. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center, or
a system implemented at least partially using cloud computing resources.

20. A system comprising:
processing circuitry to perform one or more operations associated with a machine based at least on a final detection result, the final detection result determined based at least on two or more individual detection results computed using two or more distinct algorithms executed on two or more distinct hardware components of the machine.
